(19) United States
(12) Patent Application Publication
(10) Pub. No.: US 2024/0146136 A1
(43) Pub. Date: May 2, 2024

(54) MOTOR AND DRONE

(71) Applicant: NIDEC CORPORATION, Kyoto (JP)

(72) Inventors: Kosuke MIZUIKE, Kyoto (JP); Yabo HU, Kyoto (JP); Tsuyoshi HIROKAWA, Kyoto (JP); Shogo SHIMMURA, Kyoto (JP)

(21) Appl. No.: 18/456,521

(22) Filed: Aug. 28, 2023

(30) Foreign Application Priority Data
Oct. 31, 2022 (JP) 2022-174246

(51) Int. Cl. H02K 3/28; B64U 50/19; H02K 3/12

(52) U.S. Cl. CPC H02K 3/28; B64U 50/19; H02K 3/12

(57) ABSTRACT

A motor includes a rotor about a central axis, a stator having coils, and bypass bus bars connecting in-phase coils. The coils include a first-phase coil and a second-phase coil. The bypass bus bars each include a first terminal part and a second terminal part. The first-phase coil and the second-phase coil are adjacent to each other in a slot in which a first lead wire extending from the first-phase coil and a second lead wire extending from the second-phase coil are each drawn to one side in an axial direction. The first lead wire is connected to the first terminal part of one of the bypass bus bars. The second lead wire is connected to the second terminal part of another of the bypass bus bars. The first terminal part and the second terminal part are aligned in a circumferential direction and shifted in a radial direction.

### CROSS-REFERENCE TO RELATED APPLICATIONS

The present invention claims priority under 35 U.S.C. § 119 to Japanese Patent Application No. 2022-174246 filed on Oct. 31, 2022, the entire content of which is incorporated herein by reference.

### FIELD OF THE INVENTION

The present invention relates to a motor and a drone.

### BACKGROUND ART

Known structural examples of a motor such as a three-phase AC motor include a structure in which in-phase coils are connected by a bus bar when a flat wire is used for a coil, for example. Patent Document 1 discloses a structure in which adjacent coils are connected to each other by armature winding in the shape of a bus bar in a stator with delta connection.

### PRIOR ART DOCUMENT

### Patent Document

[Patent Document 1] JP 2017-28831 A

### SUMMARY OF THE INVENTION

### Problems to be Solved by the Invention

In-phase coils disposed at intervals in a circumferential direction, for example, increase concern that commutators intersect each other in the circumferential direction to cause conduction between the commutators.

In view of the circumstances above, it is an object of an aspect of the present invention to provide a motor with high reliability in which coils separated in a circumferential direction are connected to each other by a bus bar while insulation from coils of other phases is ensured, and a drone.

### Means for Solving the Problems

An aspect of a motor of the present invention includes a rotor that rotates about a central axis, a stator having a plurality of coils disposed in a circumferential direction, and a bus bar unit having a plurality of bus bars. The plurality of coils is classified into coils of multiple phases including a first-phase coil and a second-phase coil. In-phase AC currents flow through in-phase coils of the coils. The plurality of bus bars includes a plurality of bypass bus bars connecting the in-phase coils to each other. Each of the bypass bus bars includes a base part extending along the circumferential direction, and a first terminal part and a second terminal part positioned at respective opposite ends of the base part and connected to the respective coils different from each other. The first-phase coil and the second-phase coil are adjacent to each other in a slot in which a first lead wire extending from the first-phase coil and a second lead wire extending from the second-phase coil are each drawn to one side in an axial direction. The first lead wire is connected to the first terminal part of a first-phase bypass bus bar connecting the first-phase coils to each other and constituting the bypass bus bars. The second lead wire is connected to the second terminal part of a second-phase bypass bus bar connecting the second-phase coils to each other and constituting the bypass bus bars. The first terminal part of the first-phase bypass bus bar and the second terminal part of the second-phase bypass bus bar are disposed at respective positions aligned in a circumferential direction and shifted in a radial direction.

An aspect of a drone of the present invention includes the motor and a propeller connected to a rotor of the motor.

### Effects of the Invention

An aspect of the present invention enables providing a motor with high reliability in which coils separated in a circumferential direction are connected to each other by a bus bar while insulation from coils of other phases is ensured, and a drone.

### BRIEF DESCRIPTION OF THE DRAWINGS

FIG. 1 is a perspective view illustrating a drone according to an embodiment.

FIG. 2 is a schematic sectional view illustrating a motor according to an embodiment.

FIG. 3 is a perspective view illustrating a stator and a bus bar unit according to an embodiment.

FIG. 4 is a plan view illustrating a stator and a bus bar unit according to an embodiment.

FIG. 5 is a partially enlarged view of a part of FIG. 4.

FIG. 6 is a perspective view of a coil according to an embodiment.

FIG. 7 is a schematic diagram illustrating a connection configuration of a plurality of coils according to an embodiment.

### EMBODIMENTS FOR CARRYING OUT THE INVENTION

The drawings each illustrate a Z-axis appropriately in description below. The Z-axis indicates a direction in which a central axis J of a rotor of an embodiment described below extends. The central axis J illustrated in each drawing is a virtual axis. The description below shows a direction in which the central axis J extends, or a direction parallel to a Z-axis, the direction being referred to as an “axial direction”. A radial direction around the central axis J is simply referred to as a “radial direction”. A circumferential direction around the central axis J is simply referred to as a “circumferential direction”. The axial direction includes a side (+Z side) indicated by an arrow of the Z-axis, the +Z side being referred to as an “upper side” or “one side in the axial direction”. The axial direction includes a side (−Z side) opposite to the side indicated by an arrow of the Z-axis, the −Z side being referred to as a “lower side” or “the other side in the axial direction”. The radial direction includes a side facing the central axis J in the radial direction, the side being referred to as a “radially inside” or “the other side in the radial direction”. The radial direction includes another side opposite to the side facing the central axis J in the radial direction, the other side being referred to as a “radially outside” or “one side in the radial direction”. The upper side and the lower side are simply terms for describing a relative positional relationship of components, and thus an actual placement relationship and the like may be other than the placement relationship and the like indicated by these terms.

The circumferential direction is indicated by an arrow θ in each drawing. The circumferential direction includes a side indicated by the arrow θ, the side being referred to as “one side in the circumferential direction”. The circumferential direction includes another side opposite to the side indicated by the arrow θ, the other side being referred to as “the other side in the circumferential direction”. The one side in the circumferential direction is a side (+θ side) proceeding counterclockwise around the central axis J when viewed from the upper side (+Z side). The other side in the circumferential direction is a side (−θ side) proceeding clockwise around the central axis J when viewed from the upper side.

### <Drone>

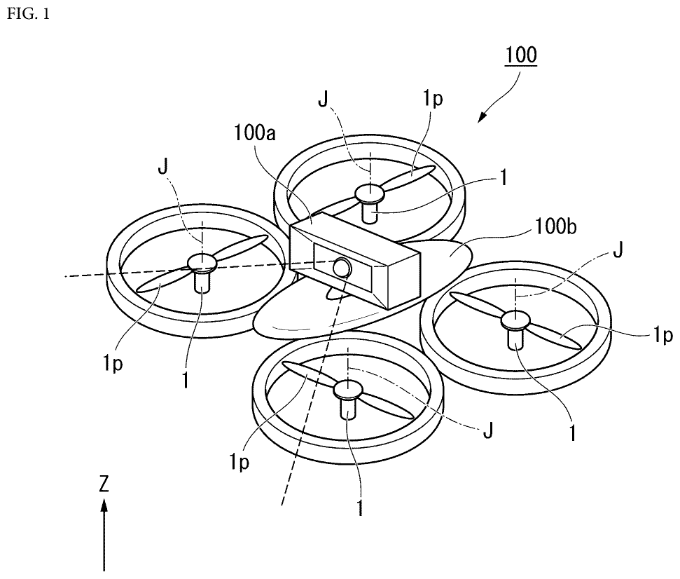

FIG. 1 is a perspective view illustrating a drone 100 according to the present embodiment.

The drone 100 according to the present embodiment includes a body 100b, an imaging device 100a, a plurality of (four in the present embodiment) motors 1, and propellers 1p connected to respective rotors of corresponding motors 1. Each of the motors 1 rotates the corresponding one of the propellers 1p about the central axis J. The body 100b is connected to the imaging device 100a and the plurality of motors 1. The body 100b controls the plurality of motors 1 to adjust rotation speed of the corresponding propellers 1p, thereby generating a propulsive force in a desired direction.

### <Motor>

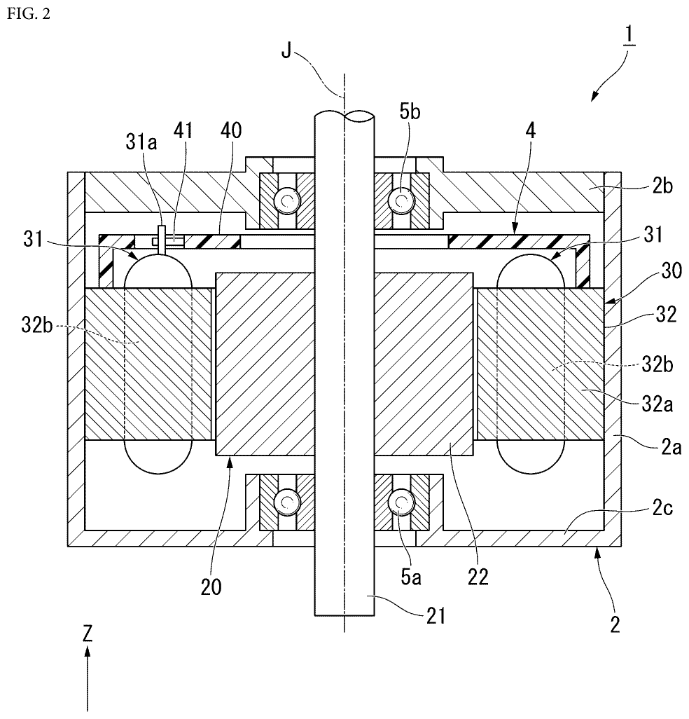

FIG. 2 is a schematic sectional view illustrating a motor according to the present embodiment.

The motor 1 according to the present embodiment is an inner rotor type three-phase AC motor. The three phases include a U-phase (first phase), a V-phase (second phase), and a W-phase (third phase). Although the present embodiment exemplifies the motor 1 mounted on a drone, a device to which the motor 1 is attached is not limited thereto.

The motor 1 includes a rotor 20 that rotates about the central axis J, a stator 30 radially facing the rotor 20, a bus bar unit 4 located above the stator 30, a pair of bearings 5a and 5b, and a housing 2.

The housing 2 accommodates the rotor 20, the stator 30, and the bus bar unit 4 therein. The housing 2 includes a tubular part 2a, an upper cover part 2b, and a lower cover part 2c. The tubular part 2a and the lower cover part 2c in the present embodiment are connected forming a single member. The tubular part 2a has a cylindrical shape extending in the axial direction about the central axis J. The upper cover part 2b is fixed to an upper end part of the tubular part 2a while covering an upper opening of the tubular part 2a. The upper cover part 2b supports a shaft 21 of the rotor 20 with the bearing 5b interposed therebetween. The lower cover part 2c extends radially inside from a lower end part of the tubular part 2a while covering a lower opening of the tubular part 2a. The lower cover part 2c supports the shaft 21 with the bearing 5a interposed therebetween.

### <Rotor>

The rotor 20 includes a rotor core 22, a magnet (not illustrated), and the shaft 21. The rotor core 22 has a cylindrical shape extending in the axial direction about the central axis J. The rotor core 22 radially surrounds the shaft 21. The rotor core 22 is provided with a plurality of magnets fixed. The plurality of magnets is disposed side by side in the circumferential direction with alternate change in magnetic pole.

The shaft 21 extends in the axial direction about the central axis J. The shaft 21 is fixed to an inner peripheral surface of the rotor core 22. The shaft 21 includes an upper end part to which a propeller 1p illustrated in FIG. 1 is fixed. The shaft 21 is rotatably supported by the pair of bearings 5a and 5b.

### <Stator>

The stator 30 encloses the rotor 20 from a radially outside. The stator 30 is fixed to an inner peripheral surface of the tubular part 2a.

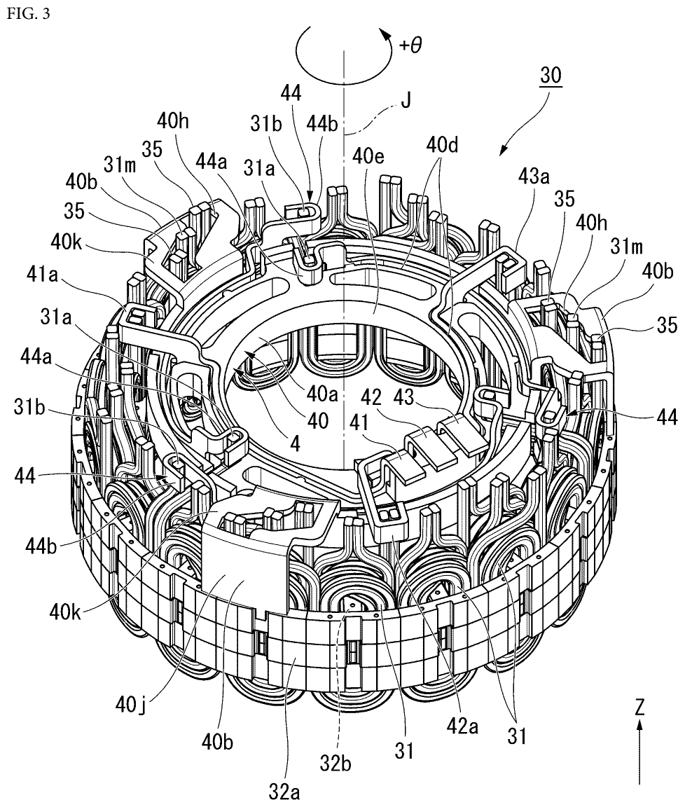

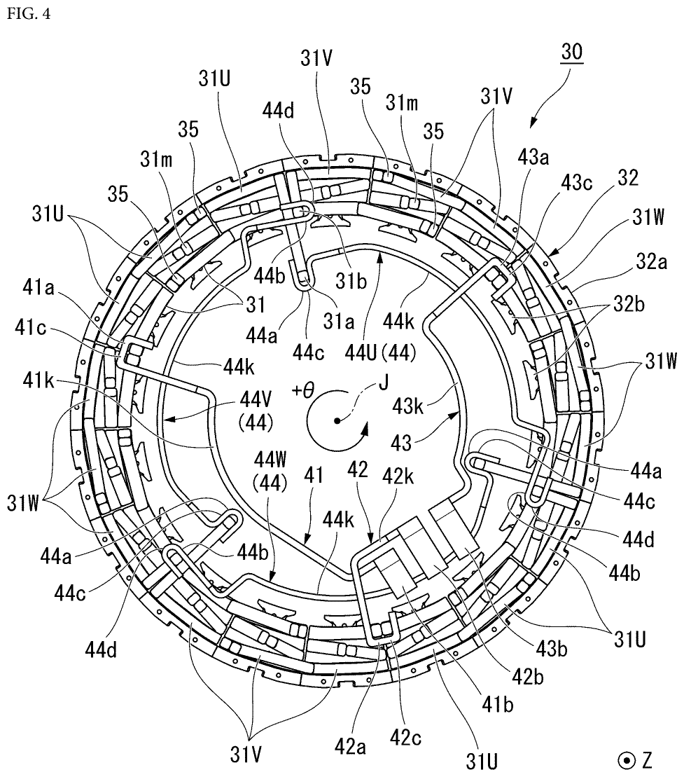

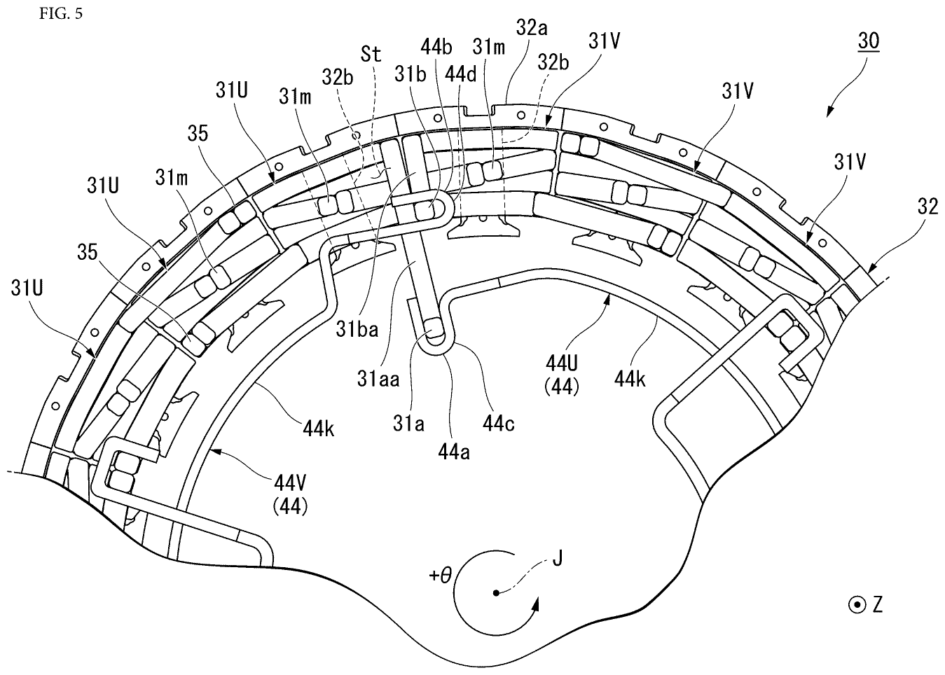

FIG. 3 is a perspective view of the stator 30 and the bus bar unit 4. FIG. 4 is a plan view of the stator 30 and the bus bar unit 4. FIG. 5 is a partially enlarged view of a part of FIG. 4. FIGS. 4 and 5 do not illustrate a bus bar holder 40 included in the bus bar unit 4.

As illustrated in FIG. 3, the stator 30 includes a stator core 32 and a plurality of coils 31. Although not illustrated in each drawing, an insulator (not illustrated) interposed between the stator 30 and the coil 31 is provided in the stator 30. The insulator is made of an insulating material.

The stator core 32 has a cylindrical shape extending in the axial direction about the central axis J. The stator core 32 surrounds the rotor 20 in the radial direction. The stator core 32 includes a core back part 32a and a plurality of tooth parts 32b.

The core back part 32a has an annular shape with a center of the central axis J. The core back part 32a includes an outer peripheral surface fixed to the inner peripheral surface of the tubular part 2a. This configuration allows the stator 30 to be fixed to the housing 2.

The tooth parts 32b each extends radially inside from the core back part 32a. The tooth parts 32b each faces the rotor 20 with a gap therebetween in the radial direction. The tooth parts 32b are disposed at intervals along the circumferential direction. The stator core 32 of the present embodiment is provided with eighteen tooth parts 32b.

The coils 31 are each attached to the tooth part 32b with an insulator (not illustrated) interposed therebetween. Thus, the coils 31 are disposed side by side in the circumferential direction.

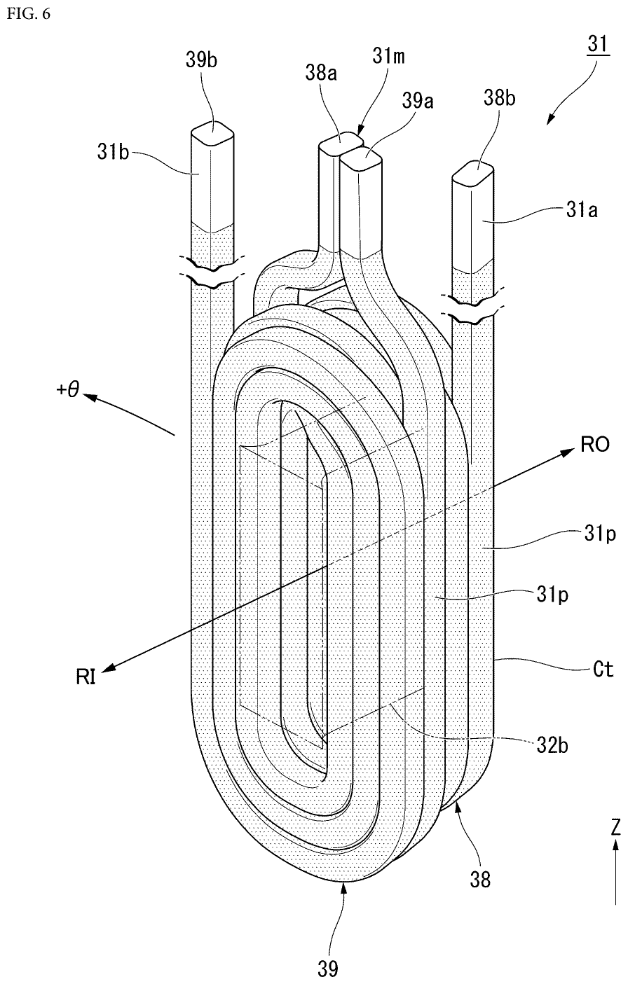

FIG. 6 is a perspective view of the coil 31 of the present embodiment. FIG. 6 illustrates a radially inside RI and a radially outside RO with respect to the central axis J with respective arrows.

The coil 31 includes a plurality of winding bodies 38 and 39 and an intermediate connection part 31m connecting the plurality of winding bodies 38 and 39. The coil 31 of the present embodiment is provided with two winding bodies 38 and 39.

The winding bodies 38 and 39 paired are each formed by winding a flat wire 31p. That is, the coil 31 is composed of the flat wire 31p. The coil 31 has a cross-section in a rounded quadrangular shape, for example. Using the flat wire 31p as a conductive wire constituting the coil 31 causes a gap between conductive wires to be less likely to be formed in a slot, and thus enables increasing a space factor of the conductive wires in the slot.

The flat wire 31p includes a surface covered with an enamel coating (coating) Ct serving as a coating of insulation. The flat wire 31p also includes opposite end parts with surfaces exposed from the enamel coating Ct. The flat wire 31p is connected at the opposite end parts to another flat wire 31p or a terminal of the bus bar unit 4, the opposite end parts having the surfaces exposed.

The winding bodies 38 and 39 paired are aligned radially with respect to the central axis J. That is, the winding bodies 38 and 39 paired are disposed side by side along a protruding direction of one tooth part 32b. When the two winding bodies 38 and 39 are distinguished from each other in description below, one located on the radially outside RO with respect to the central axis J is referred to as a first winding body 38, and the other located on the radially inside RI with respect to the central axis J is referred to as a second winding body 39. That is, the present embodiment allows the first winding body 38 to constitute a part of the radially outside RO of one coil 31, and the second winding body 39 to constitute a part of the radially inside RI of the one coil 31.

The winding bodies 38 and 39 paired of the present embodiment are each wound around the tooth part 32b by alpha winding. Thus, the opposite end parts of the flat wire 31p constituting each of the winding bodies 38 and 39 are drawn toward the upper side (+Z side) from an outermost periphery of corresponding one of the winding bodies 38 and 39.

The first winding body 38 in the present embodiment is formed by stacking three layers of windings aligned and wound in two rows aligned in the radial direction. The first winding body 38 accordingly has six windings in total. Similarly, the second winding body 39 in the present embodiment is formed by stacking three layers of windings aligned and wound in two rows aligned in the radial direction. The second winding body 39 accordingly has six windings in total. That is, the winding bodies of the present embodiment are equal to each other in number of rows aligned in the radial direction and in number of layers wound and stacked. The first winding body 38 and the second winding body 39 are connected to each other at the intermediate connection part 31m, so that one coil 31 has twelve windings in total.

The present embodiment allows the flat wire 31p constituting the first winding body 38 and the flat wire 31p constituting the second winding body 39 to be different in cross-sectional shape and substantially equal in cross-sectional area. More specifically, the winding bodies 38 and 39 include the winding body 38 in which the flat wire 31p located on the radially outside has a cross section larger in the circumferential direction (direction of the arrow θ) and smaller in the radial direction (direction of arrows RI, RO) than a cross section of the flat wire 31p located on the radially inside. This configuration enables the winding bodies 38 and 39 to coincide in cross-sectional shape with that of the slot in a substantially fan shape, and thus enables the coil 31 to increase the space factor of the flat wire 31p in the slot.

The flat wire 31p constituting the first winding body 38 includes a pair of end parts 38a and 38b extending toward the upper side (+Z) from respective ends of the first winding body 38, the respective end parts being located on opposite sides in the circumferential direction, and located radially inside and outside. Similarly, the flat wire 31p constituting the second winding body 39 includes a pair of end parts 39a and 39b extending toward the upper side (+Z) from respective ends of the second winding body 39, the respective end parts being located not only on opposite sides in the circumferential direction, but also radially inside and outside.

The first winding body 38 and the second winding body 39 are connected to each other at the intermediate connection part 31m. The intermediate connection part 31m is formed by connecting one end part 38a of the flat wire 31p constituting the first winding body 38 and one end part 39a of the flat wire 31p constituting the second winding body 39 to each other. That is, the intermediate connection part 31m is formed by connecting the end parts 38a and 39a of the flat wires drawn to the upper side (+Z side) from the pair of winding bodies 38 and 39 adjacent in the radial direction. The first winding body 38 and the second winding body 39 are connected in series to constitute one coil 31.

The intermediate connection part 31m is disposed at the center in the circumferential direction of the coil 31 when viewed from the axial direction. The intermediate connection part 31m is also disposed between the first winding body 38 and the second winding body 39 when viewed from the axial direction. A method for connecting the end parts 38a and 39a of the flat wires 31p to each other at the intermediate connection part 31m is not particularly limited. The end parts 38a and 39a may be fixed to each other by soldering or by laser welding.

The flat wire 31p constituting the first winding body 38 includes the pair of end parts 38a and 38b one of which is not connected to the second winding body 39, the one being drawn out to the upper side (+Z side) to constitute a first lead wire 31a of the coil 31. The flat wire 31p constituting the second winding body 39 includes the pair of end parts 39a and 39b one of which is not connected to the first winding body 38, the one being drawn out to the upper side (+Z side) to constitute a second lead wire 31b of the coil 31. That is, the coil 31 includes the first lead wire 31a and the second lead wire 31b. The first lead wire 31a extends toward the upper side (+Z side) from an end part of the coil 31, the end part being located on the radially outside RO and on the other side in the circumferential direction (−θ side). Then, the second lead wire 31b extends toward the upper side (+Z side) from an end part of the coil 31, the end part being located on the radially inside RI and on the one side in the circumferential direction (+θ side). The coil 31 is connected at the first lead wire 31a and the second lead wire 31b to another coil 31 or a terminal of the bus bar unit 4.

Although the plurality of coils 31 includes one half of the coils 31 in which the pair of lead wires 31a and 31b is drawn from respective drawn positions illustrated in FIG. 6, the other half of the plurality of coils 31 has a reversed winding direction, and thus circumferential positions of the pair of lead wires 31a and 31b are reversed.

Although the coil 31 including the two winding bodies 38 and 39 is described in the present embodiment, the number of winding bodies is not limited to that in the present embodiment. The number of intermediate connection parts 31m included in one coil 31 increases with increase in the number of winding bodies. For example, the coil 31 provided with three winding bodies includes two intermediate connection parts 31m. In this case, the plurality of intermediate connection parts 31m is disposed side by side along an extending direction of the tooth part 32b (or in the radial direction).

As illustrated in FIG. 4, the stator 30 of the present embodiment includes eighteen coils 31. The eighteen coils 31 are classified into six U-phase coils (first-phase coils) 31U, six V-phase coils (second-phase coils) 31V, and six W-phase coils (third-phase coils) 31W. That is, the plurality of coils 31 are classified into the coils 31 in multiple phases. In-phase AC currents flow through the coils 31 in each phase. The AC currents flowing through the coils 31 different in phase are different in phase from each other. Each of AC currents out of phase with each other by 120° flows through corresponding one of the U-phase coil 31U, the V-phase coil 31V, and the W-phase coil 31W of the present embodiment. The number of coils 31 in each phase is not limited to the number in the present embodiment.

### <Bus Bar Unit>

As illustrated in FIG. 3, the bus bar unit 4 is disposed above the stator 30. The bus bar unit 4 is connected to an end part of a flat wire 31p drawn upward from the stator 30.

The bus bar unit 4 includes a bus bar holder 40 and a plurality of bus bars 41, 42, 43, and 44. The plurality of bus bars 41, 42, 43, and 44 include a first bus bar 41, a second bus bar 42, a third bus bar 43, and a plurality of (three in the present embodiment) bypass bus bars 44.

As illustrated in FIG. 4, each of the bypass bus bars 44 connects in-phase coils 31 to each other. The three bypass bus bars 44 in description below the following include one connecting the U-phase coils 31U, the one being referred to as a U-phase bypass bus bar 44U (first-phase bypass bus bar), one connecting the V-phase coils 31V, the one being referred to as a V-phase bypass bus bar 44V (second-phase bypass bus bar), and one connecting the W-phase coils 31W, the one being referred to as a W-phase bypass bus bar 44W (third-phase bypass bus bar).

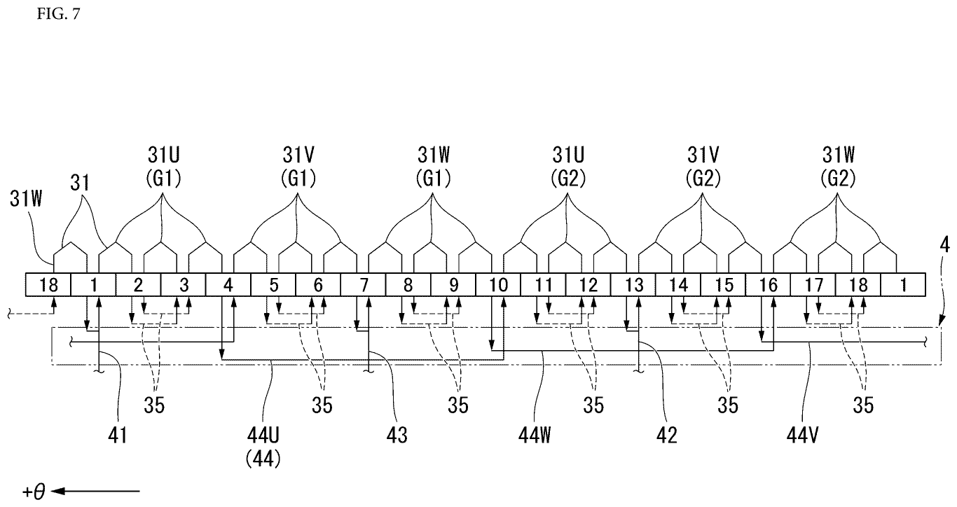

FIG. 7 is a schematic diagram illustrating a connection configuration of the eighteen coils 31 of the present embodiment. FIG. 7 illustrates a slot in which the U-phase coil 31U and the W-phase coil 31W are adjacent to each other, the slot being connected to the first bus bar 41. Then, the slot is defined as a first slot, and slots from the first slot to an eighteenth slot toward the other side in the circumferential direction (−θ side) are numbered.

The eighteen coils 31 are connected by the bus bar unit 4 to form delta connection. The in-phase coils 31 are connected in series to each other. For example, all the six U-phase coils 31U are connected in series. The six in-phase coils 31 in the present embodiment are divided into two sets with three coils continuously aligned in the circumferential direction as one set. The coils 31 of the same set have winding directions coinciding with each other. In contrast, the coils 31 of different sets have winding directions opposite to each other. Here, the term, “winding direction”, means a winding direction of winding when the tooth part 32b is viewed from the radially inside.

The coils 31 adjacent to each other in each set are connected to each other by directly connecting lead wires of the respective coils 31. Here, a connection part between the lead wires of the respective coils 31 is referred to as an inter-coil connection part 35. That is, the in-phase coils 31 aligned in the circumferential direction and belonging to the same set are connected to each other at the inter-coil connection part 35 formed by connecting end parts of the lead wires drawn upward from the respective coils 31. In contrast, the in-phase coils 31 belonging to different sets are connected to each other using the bypass bus bar 44.

The six U-phase coils 31U are classified into three U-phase coils 31U of a first set (G1) disposed from first to fourth slots and three U-phase coils 31U of a second set (G2) disposed from tenth to thirteenth slots. The three U-phase coils 31U of the first set (G1) are connected in series at two inter-coil connection parts 35. Similarly, the three U-phase coils 31U of the second set (G2) are connected in series at two inter-coil connection parts 35. Then, the U-phase coil 31U located at an end part on the other side in the circumferential direction (−θ side) of the first set (G1) and the U-phase coil 31U located at an end part on the one side in the circumferential direction (+θ) of the second set (G2) are connected to each other using the U-phase bypass bus bar 44U.

The six V-phase coils 31V are classified into three V-phase coils 31V of a first set (G1) disposed from fourth to seventh slots and three V-phase coils 31V of a second set (G2) disposed from thirteenth to sixteenth slots. The three V-phase coils 31V of the first set (G1) are connected in series at two inter-coil connection parts 35. Similarly, the three V-phase coils 31V of the second set (G2) are connected in series at two inter-coil connection parts 35. Then, the V-phase coil 31V located at an end part on the other side in the circumferential direction (−θ side) of the first set (G1) and the V-phase coil 31V located at an end part on the one side in the circumferential direction (+θ) of the second set (G2) are connected to each other using the V-phase bypass bus bar 44V.

The six W-phase coils 31W are classified into three W-phase coils 31W of a first set (G1) disposed from seventh to tenth slots and three W-phase coils 31W of a second set (G2) disposed from sixteenth to first slots. The three W-phase coils 31W of the first set (G1) are connected in series at two inter-coil connection parts 35. Similarly, the three W-phase coils 31W of the second set (G2) are connected in series at two inter-coil connection parts 35. Then, the W-phase coil 31W located at an end part on the other side in the circumferential direction (−θ side) of the first set (G1) and the W-phase coil 31W located at an end part on the one side in the circumferential direction (+θ) of the second set (G2) are connected to each other using the W-phase bypass bus bar 44W.

The first bus bar 41, the second bus bar 42, and the third bus bar 43 are each connected to an external device (not illustrated). The external device applies each of AC currents out of phase with each other by 120° to corresponding one of the first bus bar 41, the second bus bar 42, and the third bus bar 43.

The first bus bar 41 is connected to lead wires drawn from the U-phase coil 31U and the W-phase coil 31W in the first slot. The second bus bar 42 is connected to lead wires drawn from the U-phase coil 31U and the V-phase coil 31V in the thirteenth slot. The third bus bar 43 is connected to lead wires drawn from the V-phase coil 31V and the W-phase coil 31W in the seventh slot.

In general, a three-phase AC motor with concentrated winding is known to be able to reduce an axial dimension while maintaining torque by increasing the number of slots. Thus, the motor 1 for the drone 100 as in the present embodiment is desired to be reduced in weight by increasing the number of slots. Then, the motor 1 for the drone 100 is required to secure rotation speed of the propeller 1p to the extent of obtaining lift. However, excessive increase in the number of slots causes an inverter to be less likely to create an AC current of a frequency for obtaining sufficient rotation speed. The present embodiment enables providing the motor 1 excellent in balance between weight reduction and frequency for the drone 100 by setting the number of slots to eighteen.

The present embodiment allows the six in-phase coils 31 connected in series to be divided into two sets that are disposed facing each other along the central axis J. The present embodiment enables providing the motor 1 capable of rotating the propeller 1p within an appropriate range of frequencies of AC currents while allowing the rotor 20 to rotate smoothly about the central axis J.

### <Specific Configuration of Bypass Bus Bar>

As illustrated in FIG. 3, the bypass bus bar 44 extends in an arc shape along the circumferential direction. The bypass bus bar 44 is formed by pressing a conductive metal plate.

The present embodiment allows the bypass bus bars 44 for phases different from each other to be identical in shape to each other. That is, the U-phase bypass bus bar 44U, the V-phase bypass bus bar 44V, and the W-phase bypass bus bar 44W are identical in shape to each other. The present embodiment enables reducing the number of types of components constituting the bus bar unit 4, and thus enables contributing to cost reduction of the motor 1.

The bypass bus bar 44 according to the present embodiment has a direction orthogonal to the axial direction over the entire length, the direction being defined as a plate thickness direction. The bypass bus bar 44 is in a band shape having a direction along the axial direction over the entire length, the direction being defined as a width direction.

The bypass bus bar 44 includes a base part 44k, a first terminal part 44a, and a second terminal part 44b. The first terminal part 44a and the second terminal part 44b are connected to respective coils 31 different from each other. The bypass bus bar 44 connects the in-phase coils 31, so that the coil 31 connected to the first terminal part 44a and the coil 31 connected to the second terminal part 44b are in-phase with each other.

The base part 44k extends in an arc shape along the circumferential direction. The base part 44k has an arc center aligned with the central axis J. The base part 44k includes an end part on the one side in the circumferential direction (+θ side) at which the first terminal part 44a is disposed. Then, the base part 44k includes an end part on the other side in the circumferential direction (−θ side) at which the second terminal part 44b is disposed. That is, the first terminal part 44a and the second terminal part 44b are positioned at the respective opposite ends of the base part 44k.

The first terminal part 44a extends toward the other side (inside in the present embodiment) in the radial direction with respect to the base part 44k. Then, the second terminal part 44b extends toward the one side (outside in the present embodiment) in the radial direction with respect to the base part 44k. That is, the first terminal part 44a and the second terminal part 44b extend toward respective sides opposite to each other in the radial direction. The present embodiment allows the first terminal part 44a and the second terminal part 44b to be easily disposed at respective radial positions away from each other. As a result, when the first terminal parts 44a and the second terminal parts 44b of different bypass bus bars 44 are disposed overlapping each other in the radial direction, insulation between the first terminal parts 44a and the second terminal parts 44b can be easily ensured. Additionally, the bypass bus bar 44 according to the present embodiment enables a bus bar length from the first terminal part 44a to the second terminal part 44b to be shortened while shifting the first terminal part 44a and the second terminal part 44b in the radial direction as compared with the first terminal part and the second terminal part that extend collectively toward the one side in the radial direction with respect to the base part. As a result, the amount of conductive material used in the bypass bus bar 44 can be reduced, and electrical resistance in the bypass bus bar 44 can be reduced.

The first terminal part 44a is connected to the first lead wire 31a of the coil 31. The first terminal part 44a includes a first clamping part 44c. The first clamping part 44c has a U shape when viewed from the axial direction, and clamps the first lead wire 31a from opposite sides in the circumferential direction. The first clamping part 44c opens toward the radially outside when viewed from the axial direction.

Similarly, the second terminal part 44b is connected to the second lead wire 31b of the coil 31. The second terminal part 44b includes a second clamping part 44d. The second clamping part 44d has a U shape when viewed from the axial direction, and clamps the second lead wire 31b of the coil 31 from the inside and outside in the radial direction. The second clamping part 44d opens toward the one side in the circumferential direction (+θ side) when viewed from the axial direction.

The first terminal part 44a and the second terminal part 44b according to the present embodiment include the clamping parts 44c and 44d for clamping the first lead wire 31a and the second lead wire 31b, respectively, when viewed from the axial direction. The clamping parts 44c and 44d are fixed to the lead wires 31a and 31b by being clamped to the lead wires 31a and 31b, respectively. As a result, when the first terminal part 44a and the second terminal part 44b are joined to the lead wires 31a and 31b, respectively, by laser welding, a joint position can be stabilized, and thus enabling highly reliable connection to be achieved. Alternatively, the first terminal part 44a and the second terminal part 44b may be joined to the lead wires 31a and 31b, respectively, by resistance welding. In this case, welding performed by clamping the clamping parts 44c and 44d between a pair of electrodes for resistance welding enables contact points for joining to be stabilized, and thus enables achieving welding with high reliability.

The first clamping part 44c of the first terminal part 44a and the second clamping part 44d of the second terminal part 44b according to the present embodiment open toward respective directions different from each other when viewed from the axial direction. The clamping parts 44c and 44d are each clamped by a jig or the like (a crimping jig or electrodes for resistance welding) from a direction orthogonal to a direction in which corresponding one of the clamping parts 44c and 44d opens in a step of connecting the lead wires 31a and 31b. Thus, a space for disposing the jig or the like is required in the direction orthogonal to the direction in which the corresponding one of the clamping parts 44c and 44d opens. The present embodiment enables selecting an appropriate opening direction in which a space is easily secured around each of the clamping parts 44c and 44d by allowing the first clamping part 44c and the second clamping part 44d to opens in respective directions different from each other. As a result, the step of connecting the lead wires 31a and 31b to the first terminal part 44a and the second terminal part 44b, respectively, can be simplified.

The second terminal part 44b according to the present embodiment is disposed overlapping the coil 31 when viewed from the axial direction. Thus, other parts such as the intermediate connection part 31m are disposed on opposite sides of the second terminal part 44b in the circumferential direction. The present embodiment enables the jig or the like for clamping the second clamping part 44d to be disposed radially inside or outside the second clamping part 44d in a step of manufacturing by allowing the second clamping part 44d to open in the circumferential direction, and thus enables preventing the jig or the like from interfering with the other parts.

In contrast, the first terminal part 44a according to the present embodiment is disposed radially inside the coil 31 when viewed from the axial direction. Thus, a sufficient space can be easily secured on opposite sides of the first terminal part 44a in the circumferential direction. On the radially inside of the first terminal part 44a, other parts such as the second terminal part 44b and the intermediate connection part 31m are disposed. The present embodiment enables the jig or the like for clamping the first clamping part 44c to be disposed on opposite sides of the first clamping part 44c in the circumferential direction in the step of manufacturing by allowing the first clamping part 44c to open in the radial direction, and thus enables preventing the jig or the like from interfering with the other parts.

In the present specification, it is determined whether the clamping parts 44c and 44d opens in respective directions different from each other by a direction of each opening with respect to the radial direction. For example, even when the pair of clamping parts 44c and 44d of one bypass bus bar 44 opens in the same direction (e.g., +X direction) in an XY coordinate system orthogonal to the central axis J, the clamping parts 44c and 44d are determined to open in respective directions different from each other when the respective directions are each different in angle and direction with respect to a radial direction connecting the central axis J and corresponding one of the clamping parts 44c and 44d. Then, when the pair of clamping parts 44c and 44d of one bypass bus bar 44 opens toward the central axis J, for example, the clamping parts 44c and 44d are determined to open in the same direction even when the clamping parts 44c and 44d open in different directions (e.g., +X direction and +Y direction) in the XY coordinate system orthogonal to the central axis J. That is, the pair of clamping parts 44c and 44d is required to open in respective directions different from each other only in a polar coordinate system about the central axis J.

As illustrated in FIG. 3, the first terminal part 44a and the second terminal part 44b according to the present embodiment are located at respective positions aligning with each other in the axial direction. More specifically, the first terminal part 44a and the second terminal part 44b include respective upper ends at positions equal in height. Thus, not only the first terminal part 44a and first lead wire 31a, but also the second terminal part 44b and the second lead wire 31b, can be welded by laser welding with a laser set to the same focal length. As a result, the focal length is not required to be adjusted in a step of welding, and thus the step of welding can be simplified.

Next, a slot is focused in which coils 31 different in phase are adjacent to each other as illustrated in FIG. 5. The slot in which the coils 31 different in phase are adjacent to each other is referred to as a boundary slot (slot) St. Although here the boundary slot St in which the U-phase and V-phase coils 31 are adjacent to each other will be described, a boundary slot St in which coils in other phases (U-phase and W-phase, or V-phase and W-phase) are adjacent to each other has a similar configuration. The configuration in the boundary slot St in which the coils in other phases are adjacent to each other will not be described here.

The U-phase coil 31U is located on the one side in the circumferential direction (+θ side) with respect to the boundary slot St, and the V-phase coil 31V is located on the other side in the circumferential direction (−θ side) with respect to the boundary slot St. The boundary slot St of the U-phase coil 31U and the V-phase coil 31V allows the first lead wire 31a extending from the U-phase coil 31U and the second lead wire 31b extending from the V-phase coil 31V to be drawn upward (+Z side).

The first lead wire 31a is drawn upward from an end part on the radially outside and the other side in the circumferential direction (−θ side) of the U-phase coil 31U, further bent radially inside, and further bent upward at its leading end part. The first lead wire 31a includes a part extending in the radial direction, the part being referred to as a first extension 31aa. That is, the first lead wire 31a includes the first extension 31aa. The first extension 31aa has a length longer than a length of the boundary slot St along the radial direction. Thus, the leading end part of the first lead wire 31a is disposed radially inside the boundary slot St when viewed from the axial direction. The leading end part of the first lead wire 31a is located at a position aligning with the boundary slot St in the circumferential direction.

The second lead wire 31b is drawn upward from an end part on the radially outside and the one side in the circumferential direction (+θ side) of the V-phase coil 31V, further bent radially inside, and further bent upward at its leading end part. The second lead wire 31b includes a part extending in the radial direction, the part being referred to as a second extension 31ba. That is, the second lead wire 31b includes the second extension 31ba. The second extension 31ba has a length shorter than the length of the boundary slot St along the radial direction. Thus, the leading end part of the second lead wire 31b aligns with the boundary slot St at an end part on the radially inside of the boundary slot St when viewed from the axial direction. Thus, the leading end part of the second lead wire 31b is located at a position aligning with the boundary slot St in the circumferential direction.

The first lead wire 31a is connected to the first terminal part 44a of the U-phase bypass bus bar 44U. Then, the second lead wire 31b is connected to the second terminal part 44b of the V-phase bypass bus bar 44V. The first terminal part 44a of the U-phase bypass bus bar 44U and the second terminal part 44b of the V-phase bypass bus bar 44V are disposed at respective positions aligned in the circumferential direction and shifted in the radial direction.

The first lead wire 31a and the second lead wire 31b according to the present embodiment are drawn from the coils 31 different in phase, and thus currents flowing therethrough are different from each other in phase. Both the first lead wire 31a and the second lead wire 31b are drawn out from one boundary slot St and have connection parts with the bypass bus bar 44, and thus the connection parts are likely to approach each other. As illustrated in FIG. 6, the first lead wire 31a and the second lead wire 31b each include the leading end parts from which the enamel coating Ct is removed to be connected to the bypass bus bar 44. That is, the flat wire 31p has a surface exposed from the enamel coating Ct at each of the connection parts with the first terminal part 44a and the second terminal part 44b. Thus, when the leading end parts of the first lead wire 31a and the second lead wire 31b approach each other, conduction is likely to occur between the coils 31 different in phase.

As illustrated in FIG. 5, the first terminal part 44a of the U-phase bypass bus bar 44U and the second terminal part 44b of the V-phase bypass bus bar 44V according to the present embodiment are disposed at respective positions aligned in the circumferential direction and shifted in the radial direction. This configuration enables the leading end part of the first lead wire 31a connected to the first terminal part 44a of the U-phase bypass bus bar 44U and the leading end part of the second lead wire 31b connected to the second terminal part 44b of the V-phase bypass bus bar 44V to be disposed away from each other in the radial direction while being close to each other in the circumferential position.

The present embodiment enables securing insulation between the first lead wire 31a and the second lead wire 31b without providing a coating of insulation such as varnish at the connection part not only between the first lead wire 31a and the first terminal part 44a, but also between the second lead wire 31b and the second terminal part 44b. Thus, the motor 1 with high reliability can be provided at low cost.

The present embodiment does not require the first lead wire 31a and the second lead wire 31b drawn out from the boundary slot St to be bent in the circumferential direction for separation in the circumferential direction. Thus, a step of bending the first lead wire 31a and the second lead wire 31b can be simplified. Additionally, a space for disposing other parts (e.g., the intermediate connection part 31m) is likely to be secured on opposite sides of the first lead wire 31a and the second lead wire 31b in the circumferential direction, and thus the stator 30 can be downsized as a whole.

The U-phase coil 31U is located on the one side in the circumferential direction (+θ side) with respect to the boundary slot St, and the U-phase bypass bus bar 44U extends toward the other side in the circumferential direction (−θ side) with respect to the boundary slot St. In contrast, the V-phase coil 31V is located on the other side in the circumferential direction (−θ side) with respect to the boundary slot St, and the V-phase bypass bus bar (44V) extends toward the one side in the circumferential direction (+θ side) with respect to the boundary slot St. That is, the present embodiment allows a U-phase current path and a V-phase current path to intersect each other in the boundary slot St. The motor 1 according to the present embodiment enables securing insulation between two phases even when the current paths of the two phases intersect in the boundary slot St in the stator 30.

The second terminal part 44b of the V-phase bypass bus bar 44V according to the present embodiment passes over the first extension 31aa of the first lead wire 31a. That is, when viewed from the axial direction, the first lead wire 31a intersects the second terminal part 44b of the V-phase bypass bus bar 44V at the first extension 31aa. The first extension 31aa is coated with the enamel coating Ct. Thus, conduction of the first lead wire 31a is less likely to occur even when the first lead wire 31a approaches the V-phase bypass bus bar 44V at the first extension 31aa. The motor 1 according to the present embodiment enables suppressing conduction while paths of currents different in phase are intersected each other when viewed from the axial direction.

The boundary slot St according to the present embodiment allows the first lead wire 31a and the second lead wire 31b to extend in the radial direction between the intermediate connection parts 31m of the U-phase coil 31U and the V-phase coil 31V adjacent to each other in the circumferential direction. That is, the first extension 31aa and the second extension 31ba pass between the pair of intermediate connection parts 31m. The present embodiment enables the stator 30 to be downsized in the axial direction as compared with the first extension 31aa and the second extension 31ba that pass above the intermediate connection part 31m to avoid interference with the intermediate connection part 31m. The present embodiment also enables the leading end parts of the first lead wire 31a and the second lead wire 31b to be disposed away from the intermediate connection part 31m, and thus enables suppressing conduction between the leading end parts of the first lead wire 31a and the second lead wire 31b, and the intermediate connection part 31m. As a result, the step of connecting the first lead wire 31a and the second lead wire 31b to the bypass bus bar 44 can be prevented from being hindered by the intermediate connection part 31m.

The present embodiment allows the second terminal part 44b to align with the boundary slot St when viewed from the axial direction. This configuration does not require the leading end part of the second lead wire 31b connected to the second terminal part 44b to be pulled out radially inside or outside from the boundary slot St, and thus a step of processing the second lead wire 31b can be simplified. Then, the first terminal part 44a is disposed radially inside the boundary slot St when viewed from the axial direction. This configuration enables the first terminal part 44a to be sufficiently separated from the second terminal part 44b in the radial direction. Although the second lead wire 31b according to the present embodiment is located radially inside the boundary slot St, even the second lead wire 31b located radially outside the boundary slot St can obtain a similar effect. That is, when the first terminal part 44a is disposed radially inside or outside the boundary slot St and the second terminal part 44b aligns with the boundary slot St when viewed from the axial direction, the effect described above can be obtained.

The first terminal part 44a according to the present embodiment is disposed radially inside the boundary slot St when viewed from the axial direction. The present embodiment does not allow the bus bar unit 4 to protrude radially outside from an outer shape of the stator 30 when viewed from the axial direction, and thus the motor 1 can be downsized in the radial direction.

### <First Bus Bar, Second Bus Bar, and Third Bus Bar>

As illustrated in FIG. 4, a direction orthogonal to the axial direction over the entire length of each of the first bus bar 41, the second bus bar 42, and the third bus bar 43 is defined as a plate thickness direction. Each of the first bus bar 41, the second bus bar 42, and the third bus bar 43 is formed by pressing a conductive metal plate.

The first bus bar 41, the second bus bar 42, and the third bus bar 43 includes base parts 41k, 42k, and 43k, terminal parts 41a, 42a, and 43a, and external device connection parts 41b, 42b, and 43b, respectively. The base parts 41k, 42k, and 43k extend along the circumferential direction. The first bus bar 41, the second bus bar 42, and the third bus bar 43 include the terminal parts 41a, 42a, and 43a extending radially outside from the base parts 41k, 42k, and 43k, respectively. Similarly, the first bus bar 41, the second bus bar 42, and the third bus bar 43 include the external device connection parts 41b, 42b, and 43b extending radially outside from the base parts 41k, 42k, and 43k, respectively. The external device connection parts 41b, 42b, and 43b are connected to an external device (not illustrated), and receive AC currents applied by the external device.

Lead wires of the U-phase bypass bus bar 44U and the W-phase bypass bus bar 44W are collectively connected to the terminal part 41a of the first bus bar 41. Lead wires of the U-phase bypass bus bar 44U and the V-phase bypass bus bar 44V are collectively connected to the terminal part 42a of the second bus bar 42. Lead wires of the V-phase bypass bus bar 44V and the W-phase bypass bus bar 44W are collectively connected to the terminal part 43a of the third bus bar 43.

The terminal parts 41a, 42a, and 43a includes clamping parts 41c, 42c, and 43c, respectively. The clamping parts 41c, 42c, and 43c each clamp two lead wires from opposite sides in the circumferential direction. The clamping parts 41c, 42c, and 43c each open toward the radially inside when viewed from the axial direction. The first bus bar 41, the second bus bar 42, and the third bus bar 43 include respectively the clamping parts 41c, 42c, and 43c that open in the same direction. The first bus bar 41, the second bus bar 42, and the third bus bar 43 include respectively the clamping parts 41c, 42c, and 43c that open in a direction different from that of each of the first clamping part 44c and the second clamping part 44d.

The present embodiment allows the terminal parts 41a, 42a, and 43a to include the clamping parts 41c, 42c, and 43c, respectively, so that lead wires of coils can be temporarily fixed to the clamping parts by clamping, and thus enabling laser welding to be stably performed. Even when the terminal parts 41a, 42a, and 43a, and the lead wires are joined by resistance welding, welding can be performed by clamping the clamping parts 41c, 42c, and 43c using a pair of electrodes for the resistance welding.

The present embodiment allows a pair of lead wires, which is to be clamped by the clamping parts 41c, 42c, and 43c, to be disposed side by side in the circumferential direction. The clamping parts 41c, 42c, and 43c each clamp the pair of lead wires disposed side by side in the circumferential direction from opposite sides in the circumferential direction. The present embodiment enables each of the clamping parts 41c, 42c, and 43c to come into contact with the pair of lead wires more reliably, and thus enables enhancing stability of connection between the pair of lead wires and each of the terminal parts 41a, 42a, and 43a.

As illustrated in FIG. 3, the terminal parts 41a, 42a, 43a of the first bus bar 41, the second bus bar 42, and the third bus bar 43 according to the present embodiment are located at respective positions aligning with each other in the axial direction. The terminal parts 41a, 42a, 43a of the first bus bar 41, the second bus bar 42, and the third bus bar 43 are located at the respective positions that also align with those of the first terminal part 44a and the second terminal part 44b in the axial direction. The present embodiment does not require a focal length of each of the terminal parts 41a, 42a, 43a, 44a, and 44b to be adjusted in a step of laser welding, and thus enables the step of laser welding to be simplified.

### <Bus Bar Holder>

As illustrated in FIG. 3, the bus bar holder 40 supports the plurality of bus bars 41, 42, 43, and 44. The bus bar holder 40 includes a holder body 40a in a disk shape about the central axis J and a plurality of (three in the present embodiment) leg parts 40b.

The holder body 40a is disposed radially inside the stator 30 when viewed from the axial direction. Thus, the holder body 40a aligns with the rotor 20 when viewed from the axial direction. The holder body 40a is provided with a central hole 40e in a circular shape about the central axis J. The shaft 21 of the rotor 20 passes through the central hole 40e.

The holder body 40a includes a surface facing upward, the surface being provided with a plurality of holding grooves 40d. Each of the holding grooves 40d extends along the circumferential direction. The base parts 41k, 42k, 43k, and 44k of the plurality of bus bars 41, 42, 43, and 44 are inserted into the corresponding plurality of holding grooves 40d. As a result, the bus bar holder 40 holds the plurality of bus bars 41, 42, 43, and 44. The bus bar holder 40 may hold the bus bars 41, 42, 43, and 44 by embedding the base parts 41k, 42k, 43k, and 44k by insert molding or the like.

The leg part 40b extends radially outside from the holder body 40a. The leg part 40b supports the holder body 40a. The plurality of leg parts 40b is disposed at equal intervals around the central axis. The leg part 40b includes a radial extension 40k extending radially outside from an outer edge of the holder body 40a and a lower extension 40j extending downward from a radially outer tip of the radial extension 40k.

The leg part 40b is in contact with an upper surface of the core back part 32a at a lower end surface of the lower extension 40j. As a result, the leg part 40b is supported by the stator 30. That is, the bus bar holder 40 is supported by the stator 30.

The radial extension 40k has a plate shape extending along a plane orthogonal to the central axis J. The radial extension 40k aligns with the coil 31 when viewed from the axial direction. The radial extension 40k is provided with a hole 40h passing through the radial extension 40k in the axial direction. That is, the leg part 40b is provided with the hole 40h passing through the leg part 40b in the axial direction. The hole 40h has an elongated hole shape extending radially outside toward the other side in the circumferential direction.

The pair of inter-coil connection parts 35 and the intermediate connection part 31m protrude upward from the coil 31 disposed immediately below the radial extension 40k. One of the pair of inter-coil connection parts 35 extends upward from an end part of the coil 31 on the one side in the circumferential direction (+θ side) and on the radially inside, and the other extends upward from an end part of the coil 31 on the other side in the circumferential direction (−θ side) and on the radially outside. The intermediate connection part 31m extends upward from the center of the coil 31 in not only the circumferential direction but also the radial direction. Thus, the one inter-coil connection part 35, the intermediate connection part 31m, and the other inter-coil connection part 35 are aligned linearly. The hole 40h extends along a direction in which the pair of inter-coil connection parts 35 and the intermediate connection part 31m are aligned. The pair of inter-coil connection parts 35 and the intermediate connection part 31m are inserted into the hole 40h.

The present embodiment allows the pair of inter-coil connection parts 35 and the intermediate connection part 31m to be inserted into the hole 40h provided in the leg part 40b. Thus, the leg part 40b can be disposed close to the coil 31 while the leg part 40b is prevented from coming into contact with the pair of inter-coil connection parts 35 and the intermediate connection part 31m, so that the motor 1 can be downsized in the axial direction.

Although various embodiments of the present invention have been described above, configurations in the respective embodiments and combinations thereof are examples, and thus, addition, omission, replacement of configurations, and other modifications can be made within a range without departing from the spirit of the present invention. The embodiments also do not limit the present invention.

For example, the motor described above may be used as a generator. The plurality of coils may be connected by star connection instead of delta connection. In this case, the number of phases of the AC current flowing through the plurality of coils is not limited to three. Although the coil composed of a conductive wire of a flat wire has been described in the embodiments described above, the coil may be composed of a conductive wire having a circular cross section. In the embodiments described above, each bus bar disposed radially inside the coil when viewed from the axial direction has been described. However, each bus bar may be disposed radially outside the coil when viewed from the axial direction.

The present technique can have configurations as described below.

(1) A motor including: a rotor that rotates about a central axis; a stator having a plurality of coils disposed in a circumferential direction; and a bus bar unit having a plurality of bus bars, the plurality of coils being classified into coils of multiple phases including a first-phase coil and a second-phase coil, the coils including in-phase coils through which in-phase AC currents flow, the plurality of bus bars including a plurality of bypass bus bars connecting the in-phase coils to each other, each of the bypass bus bars including a base part extending along the circumferential direction, and a first terminal part and a second terminal part positioned at respective opposite ends of the base part and connected to the respective coils different from each other, the first-phase coil and the second-phase coil being adjacent to each other in a slot in which a first lead wire extending from the first-phase coil and a second lead wire extending from the second-phase coil are each drawn to one side in an axial direction, the first lead wire being connected to the first terminal part of a first-phase bypass bus bar connecting the first-phase coils to each other and constituting the bypass bus bar, the second lead wire being connected to the second terminal part of a second-phase bypass bus bar connecting the second-phase coils to each other and constituting the bypass bus bar, and the first terminal part of the first-phase bypass bus bar and the second terminal part of the second-phase bypass bus bar being disposed at respective positions aligned in a circumferential direction and shifted in a radial direction.

(2) The motor according to item (1), in which the first-phase coil is located on one side in the circumferential direction with respect to the slot, the first-phase bypass bus bar extends toward another side in the circumferential direction with respect to the slot, the second-phase coil is located on the other side in the circumferential direction with respect to the slot, and the second-phase bypass bus bar extends toward the one side in the circumferential direction with respect to the slot.

(3) The motor according to item (1) or (2), in which each of the first terminal part and the second terminal part includes a clamping part that clamps the first lead wire or the second lead wire, and the clamping part of the first terminal part and the clamping part of the second terminal part open in respective directions different from each other when viewed from the axial direction.

(4) The motor according to any one of items (1) to (3), in which the first terminal part extends from the base part to one side in the radial direction, and the second terminal part extends from the base part to another side in the radial direction.

(5) The motor according to any one of items (1) to (4), in which the first terminal part and the second terminal part are located at respective positions aligning with each other in the axial direction.

(6) The motor according to any one of items (1) to (5), in which the bypass bus bars for phases different from each other are identical in shape to each other.

(7) The motor according to any one of items (1) to (6), in which the first terminal part is disposed radially inside or outside the slot when viewed from the axial direction, and the second terminal part aligns with the slot when viewed from the axial direction.

(8) The motor according to item (7), in which the first terminal part is disposed radially inside the slot when viewed from the axial direction.

(9) The motor according to any one of items (1) to (8), in which each of the coils includes a plurality of winding bodies formed by winding flat wires and aligned in a radial direction, and an intermediate connection part connecting the winding bodies, the intermediate connection part is formed by connecting end parts of the flat wires drawn to one side in the axial direction from a pair of the winding bodies adjacent in the radial direction, and the first lead wire extends in the slot and in the radial direction between the intermediate connection parts of the first-phase coil and the second-phase coil adjacent in the circumferential direction.

(10) The motor according to any one of items (1) to (9), in which the coil includes a flat wire, the flat wire has a surface covered with a coating of insulation, and the flat wire has the surface exposed from the coating at connection parts with the first terminal part and the second terminal part.

(11) The motor according to any one of items (1) to (10), in which the coil is wound by alpha winding.

(12) The motor according to any one of items (1) to (11), in which the plurality of coils includes the in-phase coils aligned in the circumferential direction, the in-phase coils aligned in the circumferential direction are connected to each other at an inter-coil connection part formed by connecting end parts of lead wires led out to the one side in the axial direction from the respective coils, the bus bar unit includes a bus bar holder that supports the plurality of bus bars, the bus bar holder includes a holder body located radially inside the stator when viewed from the axial direction, and a leg part that extends radially outside from the holder body and supports the holder body, the leg part includes a hole passing through the leg part in the axial direction, and the inter-coil connection part is inserted into the hole.

(13) The motor according to any one of items (1) to (12), in which the stator includes eighteen pieces of the coils that are connected by the bus bar unit to form delta connection, the coils include six in-phase coils divided into two sets with three coils continuously aligned in the circumferential direction as one set, the in-phase coils adjacent to each other in each of the sets are connected by a lead wire, and the in-phase coils belonging to the sets different from each other are connected by the bypass bus bar.

(14) A drone including: the motor according to any one of items (1) to (13); and a propeller connected to a rotor of the motor.

1. A motor comprising:
a rotor that rotates about a central axis;
a stator having a plurality of coils disposed in a circumferential direction; and
a bus bar unit having a plurality of bus bars,
the plurality of coils being classified into coils of multiple phases including a first-phase coil and a second-phase coil,
the coils including in-phase coils through which in-phase AC currents flow,
the plurality of bus bars including a plurality of bypass bus bars connecting the in-phase coils to each other,
each of the bypass bus bars including:
a base part extending along the circumferential direction; and
a first terminal part and a second terminal part positioned at respective opposite ends of the base part and connected to the respective coils different from each other,
the first-phase coil and the second-phase coil being adjacent to each other in a slot in which a first lead wire extending from the first-phase coil and a second lead wire extending from the second-phase coil are each drawn to one side in an axial direction,
the first lead wire being connected to the first terminal part of a first-phase bypass bus bar connecting the first-phase coils to each other and constituting the bypass bus bar,
the second lead wire being connected to the second terminal part of a second-phase bypass bus bar connecting the second-phase coils to each other and constituting the bypass bus bar, and
the first terminal part of the first-phase bypass bus bar and the second terminal part of the second-phase bypass bus bar being disposed at respective positions aligned in a circumferential direction and shifted in a radial direction.

2. The motor according to claim 1, wherein
the first-phase coil is located on one side in the circumferential direction with respect to the slot,
the first-phase bypass bus bar extends toward another side in the circumferential direction with respect to the slot,
the second-phase coil is located on the other side in the circumferential direction with respect to the slot, and
the second-phase bypass bus bar extends toward the one side in the circumferential direction with respect to the slot.

3. The motor according to claim 1, wherein
each of the first terminal part and the second terminal part includes a clamping part that clamps the first lead wire or the second lead wire, and
the clamping part of the first terminal part and the clamping part of the second terminal part open in respective directions different from each other when viewed from the axial direction.

4. The motor according to claim 1, wherein
the first terminal part extends from the base part to one side in the radial direction, and
the second terminal part extends from the base part to another side in the radial direction.

5. The motor according to claim 1, wherein the first terminal part and the second terminal part are located at respective positions aligning with each other in the axial direction.

6. The motor according to claim 1, wherein the bypass bus bars for phases different from each other are identical in shape to each other.

7. The motor according to claim 1, wherein
the first terminal part is disposed radially inside or outside the slot when viewed from the axial direction, and
the second terminal part aligns with the slot when viewed from the axial direction.

8. The motor according to claim 7, wherein the first terminal part is disposed radially inside the slot when viewed from the axial direction.

9. The motor according to claim 1, wherein
each of the coils includes a plurality of winding bodies formed by winding flat wires and aligned in the radial direction, and an intermediate connection part connecting the winding bodies,
the intermediate connection part is formed by connecting end parts of the flat wires drawn to one side in the axial direction from a pair of the winding bodies adjacent in the radial direction, and
the first lead wire extends in the slot and in the radial direction between the intermediate connection parts of the first-phase coil and the second-phase coil adjacent in the circumferential direction.

10. The motor according to claim 1, wherein
the coil includes a flat wire,
the flat wire has a surface covered with a coating of insulation, and
the flat wire has the surface exposed from the coating at connection parts with the first terminal part and the second terminal part.

11. The motor according to claim 1, wherein the coil is wound by alpha winding.

12. The motor according to claim 1, wherein
the plurality of coils includes the in-phase coils aligned in the circumferential direction,
the in-phase coils aligned in the circumferential direction are connected to each other at an inter-coil connection part formed by connecting end parts of lead wires led out to the one side in the axial direction from the respective coils,
the bus bar unit includes a bus bar holder that supports the plurality of bus bars,
the bus bar holder includes a holder body located radially inside the stator when viewed from the axial direction, and a leg part that extends radially outside from the holder body and supports the holder body,
the leg part includes a hole passing through the leg part in the axial direction, and
the inter-coil connection part is inserted into the hole.

13. The motor according to claim 1, wherein
the stator includes eighteen pieces of the coils that are connected by the bus bar unit to form delta connection,
the coils include six in-phase coils divided into two sets with three coils continuously aligned in the circumferential direction as one set,
the in-phase coils adjacent to each other in each of the sets are connected by a lead wire, and
the in-phase coils belonging to the sets different from each other are connected by the bypass bus bar.

14. A drone comprising:
the motor according to claims 1; and
a propeller connected to a rotor of the motor.
